(19) United States
(12) Patent Application Publication
(10) Pub. No.: US 2026/0147444 A1
(43) Pub. Date: May 28, 2026

(54) DATA PROCESSING METHOD, ELECTRONIC DEVICE, AND STORAGE MEDIUM

(71) Applicant: Lenovo (Beijing) Limited, Beijing (CN)

(72) Inventors: Xiang LI, Beijing (CN); Liangliang CHEN, Beijing (CN); Zhe WU, Beijing (CN); Zhan LIU, Beijing (CN)

(21) Appl. No.: 19/178,575

(22) Filed: Apr. 14, 2025

(30) Foreign Application Priority Data
Apr. 17, 2024 (CN) 202410466146.9

(51) Int. Cl. G06F 3/0482; G06F 3/0484

(52) U.S. Cl. CPC G06F 3/0482; G06F 3/0484

(57) ABSTRACT

The present disclosure describes a data processing method and device. An exemplary method includes, in response to obtaining a target object determined by a target input operation, displaying and outputting processing options matching the target object in a session window of a first application capable of performing an interactive task, where at least one of the processing options corresponding to different objects is different, and a processing option is configured to perform a corresponding processing operation on the target object after being triggered.

### CROSS-REFERENCE TO RELATED APPLICATION

This application claims priority to Chinese Patent Application No. 202410466146.9, filed on Apr. 17, 2024, the content of which is incorporated herein by reference in its entirety.

### TECHNICAL FIELD

The application generally relates to the field of data processing technology, and in particular to a data processing method and device.

### BACKGROUND

Users need to process a large amount of information in their daily lives and work, which can include text, images, mixed text and images, etc. Traditional information processing tools are often designed merely for specific types of information, such as text editors, picture editors, etc. Users need to switch frequently when using these tools, which greatly reduces the efficiency and quality of information processing.

### SUMMARY

Embodiments of the present disclosure provide a data processing method and device, and the technical solutions of the present disclosure are implemented as follows.

In one aspect, embodiments of the disclosure provide a data processing method, and the method includes, in response to obtaining a target object determined by a target input operation, displaying and outputting processing options matching the target object in a session window of a first application capable of performing an interactive task, where at least one of the processing options corresponding to different objects is different, and a processing option is configured to perform a corresponding processing operation on the target object after being triggered.

In another aspect, embodiments of the disclosure provide a data processing device, including a memory and one or more processors, where the memory stores a computer program executable by the one or more processors, and when executing the computer program, the one or more processor are configured to perform: in response to obtaining a target object determined by a target input operation, displaying and outputting processing options matching the target object in a session window of a first application capable of performing an interactive task, where at least one of the processing options corresponding to different objects is different, and a processing option is configured to perform a corresponding processing operation on the target object after being triggered.

In another aspect, embodiments of the disclosure provide a non-transitory computer-readable storage medium, storing a computer program that, when being executed, causes at least one processor to implement a data processing method including, in response to obtaining a target object determined by a target input operation, displaying and outputting processing options matching the target object in a session window of a first application capable of performing an interactive task, where at least one of the processing options corresponding to different objects is different, and a processing option is configured to perform a corresponding processing operation on the target object after being triggered.

In another aspect, embodiments of the disclosure provide a data processing device, including a processing unit configured to, in response to obtaining a target object determined by a target input operation, display and output processing options matching the target object in a session window of a first application capable of performing an interactive task, where at least one of the processing options corresponding to different objects is different, and a processing option is configured to perform a corresponding processing operation on the target object after being triggered.

In another aspect, embodiments of the disclosure provide a computer program product, which includes a computer program, and when the computer program is executed by a processor, a computation method disclosed elsewhere is implemented.

Other features of the present disclosure and advantages thereof will become apparent from the following detailed description of exemplary embodiments of the present disclosure with reference to the accompanying drawings.

### BRIEF DESCRIPTION OF THE DRAWINGS

In order to more clearly illustrate the technical solution in the embodiments of the disclosure, the drawings essential for understanding the disclosed embodiments will be briefly described below. Apparently, the drawings described below are merely some embodiments of the disclosure. For a person skilled in the art, other drawings can be obtained based on the provided drawings without making creative efforts.

FIG. 1 is a flowchart of a data processing method according to an embodiment of the present disclosure;

FIG. 2 is a flowchart of another data processing method according to an embodiment of the present disclosure;

FIG. 3 is a flowchart of yet another data processing method according to an embodiment of the present disclosure;

FIG. 4 is a flowchart of yet another data processing method according to an embodiment of the present disclosure;

FIG. 5 is a schematic diagram illustrating an interaction between a first application and a second application according to an embodiment of the present disclosure;

FIG. 6 is a schematic diagram illustrating another interaction between a first application and a second application according to an embodiment of the present disclosure;

FIG. 7 is a schematic structural diagram of a data processing device according to an embodiment of the present disclosure; and

FIG. 8 is a schematic structural diagram of an electronic device according to an embodiment of the present disclosure.

### DETAILED DESCRIPTION

In order to enable a more detailed understanding of the features and technical contents of the embodiments of the present disclosure, the implementation of the embodiments of the present disclosure is described in detail hereinafter in conjunction with the accompanying drawings. These accompanying drawings are merely for reference purposes and are not intended to limit the embodiments of the present disclosure.

Unless otherwise defined, technical and scientific terms used herein have the same meaning as those commonly understood by a person skilled in the art. The terms used herein are merely for the purpose of describing the present disclosure and are not intended to limit the disclosure.

In the following description, references to “some embodiments,” “this embodiment,” “the disclosed embodiment,” and the like describe a subset of all possible embodiments, but it can be understood that “some embodiments” can be the same subset or different subsets of all possible embodiments, which can be combined with each other without conflict.

If similar descriptions of “first/second” appear in the present disclosure, the following instructions are followed. In the following description, the terms “first/second/third” are merely used to distinguish similar objects and do not represent a specific ordering of the objects. It can be understood that “first/second/third” can be interchanged in a specific order or sequence where permitted so that the disclosed embodiment described herein can be implemented in an order other than that illustrated or described here.

In the disclosed embodiments, the term “and/or” is merely a description of the association relationship between associated objects, indicating that three relationships can exist. For example, object A and/or object B can represent three situations: object A exists alone, object A and object B exist at the same time, and object B exists alone.

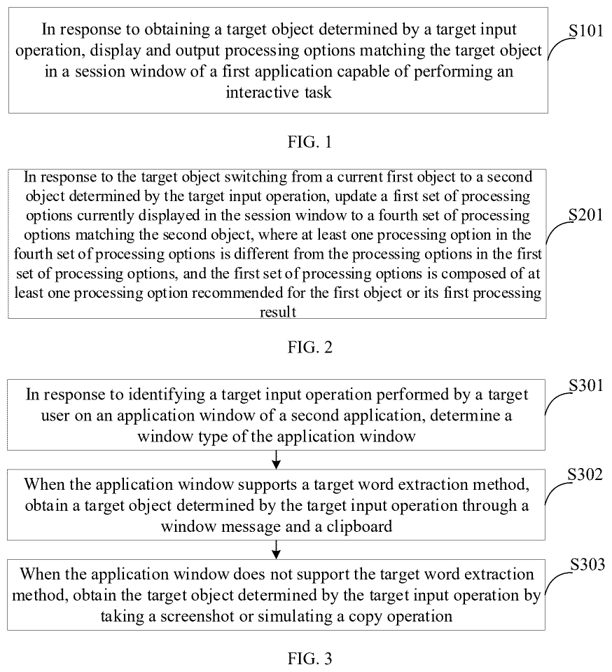

The present disclosure provides a data processing method, and FIG. 1 is a flowchart of a data processing method according to an embodiment of the present disclosure, which is applied to an electronic device. The electronic device can be a smartphone, a tablet, a desktop computer, etc. As shown in FIG. 1, the data processing method can include the following steps.
S101: In response to obtaining a target object determined by a target input operation, display and output processing options matching the target object in a session window of a first application capable of performing an interactive task.

Here, at least one of the processing options corresponding to different objects is different, and a processing option is configured to perform a corresponding processing operation on the target object after being triggered.

The target input operation can be a word selection operation, a screenshot operation, a circle selection operation, a voice input operation, a drag operation, a gesture operation, a floating operation, an eye tracking operation, etc.

The target object includes at least one of the following: text data, image data, mixed text and image data, audio data, video data, and the like.

The first application refers to an application program with intelligent functions, which is intended to provide users with convenient and efficient services. The session window of the first application can be understood as an interactive interface. The session window can be the main window of the first application, or can be an extended window or a thumbnail window.

At least one of the processing options corresponding to different objects is different. In other words, the displayed and outputted processing options will be adaptively updated for different objects, thereby improving the flexibility and efficiency of data processing.

For example, when the target object is text data, it is usually necessary to further modify the text data or raise questions, so the processing options displayed in the session window of the first application can include at least one of polish, continuing writing, and asking questions. When the target object is image data, it is usually necessary to beautify the image data, search for similar images, or raise questions, so the processing options displayed in the session window of the first application can include at least one of beautification, image search, and asking questions.

In some embodiments, displaying and outputting processing options matching the target object in the session window of the first application capable of performing an interactive task includes one of the following.

In response to obtaining the target object, load the target object into the session window of the first application, and display a first set of processing options recommended for the target object, so as to perform a corresponding processing operation on the target object in response to a selected operation of a target user.

In response to obtaining the target object, display a first processing result, obtained after performing a first processing on the target object, in the session window of the first application, and display a second set of processing options recommended for performing a second processing on the target object, so as to perform a second processing operation on the target object in response to a selected operation of the target user, where the second set of processing options does not include a processing option corresponding to the first processing.

In response to obtaining the target object, display a first processing result, obtained after performing a first processing on the target object, in the session window of the first application, and display a third set of processing options recommended for the first processing result, so as to perform a corresponding processing operation on the first processing result in response to a selected operation of the target user, where the third set of processing options includes processing options corresponding to the first processing.

In other words, the present disclosure provides three optional solutions.

For the first solution, the target object is loaded into the session window of the first application, that is, the target object is used as a question input, or as a part of the question input, and a complete question input is formed after the target user selects a corresponding processing option from the first set of processing options, so as to perform a corresponding processing operation on the target object in response to the target user's selection operation. The first set of processing options includes one or more processing options.

Exemplarily, when the target object is text data, the text data will be directly displayed in the session window of the first application, and a first set of processing options recommended for the text data will be displayed, and the first set of processing options can include at least one of polish, continuation, translation, and asking questions. When the target object is image data, the image data will be directly displayed in the session window of the first application, and a first set of processing options recommended for the image data will be displayed, and the first set of processing options can include at least one of image search, beautification, and asking questions.

For the second solution, the first processing result, obtained after the first processing of the target object, is displayed in the session window of the first application. That is, the target user can view the first processing result of the target object without any operation. If the target user is not satisfied with the first processing result of the target object, after the target user selects a corresponding processing option from the second set of processing options, a second processing operation is performed on the target object in response to the target user's selection operation. Here, the first processing can be a processing operation pointed to by the processing logic of the first recommendation, including one of the following: summarization, translation, polish, continuation, asking questions, and extraction. The first processing can also be a pre-processing operation performed on the target object, including one of the following: filtering irrelevant content, and extracting or enhancing the main content. Here, the reason why the target user selects the corresponding processing option from the second set of processing options is that he is not satisfied with the first processing result, so the second set of processing options will not include the processing option corresponding to the first processing, so as to achieve the purpose of saving certain system resources. The second set of processing options includes one or more processing options.

Exemplarily, when the target object is text data, in response to the text data, the text data is polished, the polished text data is displayed in the session window of the first application, and a second set of processing options recommended for the second processing of the text data is displayed. The second set of processing options can include at least one of continuation, translation, and questioning. When the target object is image data, in response to the image data, the image data is searched, the searched similar images are displayed in the session window of the first application, and a second set of processing options recommended for the second processing of the image data is displayed. The second set of processing options can include at least one of beautification and questioning.

For the third solution, the first processing result, obtained after the first processing of the target object, is displayed in the session window of the first application. That is, the target user can view the first processing result of the target object without any operation. If the target user is not satisfied with the first processing result of the target object, the corresponding processing option is selected from the third set of processing options to perform a corresponding processing operation on the first processing result in response to the target user's selection operation. Here, the processing object during the first processing is the target object. If the target user is not satisfied with the first processing result of the target object, the first processing result will be processed next. That is, the processing object is the first processing result, and the processing objects before and after the first processing are different. Therefore, the third set of processing options can include the processing option corresponding to the first processing. The third set of processing options includes one or more processing options.

Exemplarily, when the target object is text data, in response to the text data, the text data is polished, the polished text data is displayed in the session window of the first application, and a third set of processing options recommended for the polished text data is displayed. The third set of processing options can include polish, continuation, translation, and asking questions. When the target object is image data, in response to the image data, the image data is searched, identified similar images are displayed in the session window of the first application, and a third set of processing options recommended for the identified similar images is displayed, and the third set of processing options can include search, beautification, and asking questions.

For any of the above solutions, the selected operation of the target user can be a click operation, a gaze positioning operation, a key input operation, a voice input operation, and the like.

In some embodiments, displaying and outputting processing options matching the target object in the session window of the first application capable of performing an interactive task includes at least one of the following.

Identify attribute information of the target object, and display and output at least one matching processing option in the session window based on the attribute information.

Obtain source information of the target object, and display and output at least one matching processing option in the session window based on the source information.

Identify a user intention indicated by the target input operation and/or the target object, and display and output at least one matching processing option in the session window based on the user intention.

Obtain configuration information and operation information of an electronic device, and display and output at least one processing option matching the target object in the session window based on the configuration information and the operation information.

Obtain user portrait information of the target user, and display and output at least one processing option matching the target object in the session window based on the user portrait information and the attribute information of the target object.

Regarding how to match the processing options of the target object, the embodiments of the present disclosure provide multiple solutions, including any one of the above solutions, a combination of any two of the above solutions, a combination of any three of the above solutions, a combination of any four of the above solutions, and a combination of any five of the above solutions, all of which can match the processing options of the target object.

In the embodiments of the present disclosure, the attribute information of the target object at least includes the type of the target object and language type. That is, based on the type of the target object and language type, at least one matching processing option is displayed and outputted in the session window. Here, the type of the target object includes short words, long sentences, images, mixed images and texts, select all, etc. The language types include Chinese and foreign languages. The attribute information of the target object can also include display parameters, which can include size, resolution, etc.

Exemplarily, when the target object is text data, if the type of the text data is identified as a long sentence and the language type is Chinese, the matching processing options displayed and outputted in the session window can include at least one of summarization, continuation, and translation. When the target object is text data, if the type of the text data is identified as a short word and the language type is Chinese, the matching processing options displayed and outputted in the session window can include at least one of polish, extraction, and asking questions.

In the embodiments of the present disclosure, the source information of the target object refers to which application the target object comes from, for example, a browser, a document, a PowerPoint (PPT), an album, a social application, etc. Here, different processing options are recommended for different sources.

Exemplarily, when the target object is text data, if the text data comes from a document application, the processing options displayed in the session window can include at least one of copy, interpretation, and translation. When the target object is text data, if the text data comes from a social application, the processing options displayed in the session window can include at least one of share, copy, and translation.

In the embodiments of the present disclosure, by identifying the user intention indicated by the target input operation and/or the target object, at least one matching processing option is displayed and outputted in the session window according to the user intention, thereby improving the user experience.

For example, if the target input operation is a word selection operation, the user intention indicated by it can be copy, share, asking questions, etc., so the processing options displayed in the session window can include copy, share, asking questions, etc. If the target object is a short word, the user intention indicated by it can be to learn more about the short word, so the processing options displayed in the session window can include search, interpretation, and translation.

In the embodiments of the present disclosure, the configuration information of an electronic device includes hardware configuration, software configuration, or functional service configuration. The operation information of the electronic device refers to various states and performance data of the electronic device during operation, including but not limited to the operation state, performance parameters, error logs, resource usage, and the like for the electronic device. Here, based on the configuration information and operation information of the electronic device, at least one processing operation that the first application can perform on the target object can be determined, and then at least one processing option corresponding to the at least one processing operation is displayed in the session window. In this way, it can be ensured that the electronic device will not crash due to resource problems.

In the embodiments of the present disclosure, the user portrait information of a target user refers to the information used to identify the target user. The user portrait information can include at least one of the following: user identification, user habit data, and user historical behavior data. Here, the attribute information of the target user and the target object is comprehensively considered to recommend processing options to improve the user experience.

Exemplarily, in a case where the user portrait information includes user habit data, if the target object is text data, and the type of the identified text data is a single word, and the user is used to ask questions about single words, the processing options displayed in the session window then include a question option. If the type of the identified text data is a long sentence, and the user is used to generate summaries for long sentences, the processing options displayed in the session window then include a summarization option. If the target object is an image, and the user is used to beautify images, the processing options displayed in the session window then include a beautification option.

Exemplarily, in some embodiments, based on the attribute information and source information of the target object, at least one matching processing option is displayed and outputted in the session window.

Exemplarily, when the target object is image data, if the image data comes from a social application, the processing options displayed in the session window can include at least one of beautification, questioning, and image search. If the image data comes from a browser, the processing options displayed in the session window can include at least one of image search and recognition. When the target object is text data, if the text data comes from a social application, the processing options displayed in the session window can include at least one of copy and translation. If the text data comes from a browser, the processing options displayed in the session window can include at least one of extraction, translation, and questioning. That is, for target objects with the same attributes, when the source information is different, at least one of the matching processing options is different.

In some embodiments, at least one matching processing option is displayed and outputted in the session window based on the attribute information, including at least one of the following.

In a case where the target object includes text data, display in the session window at least one processing option including one for changing the data amount or type of the text data and/or for obtaining associated data of the text data.

In a case where the target object includes image data, display in the session window at least one processing option including one for changing an image parameter or type of the image data and/or for acquiring associated data of the image data.

In a case where the target object includes an access address, display in the session window at least one processing option including one for changing an access mode or an output type of content corresponding to the access address.

In a case where the target object includes media playback data, display in the session window at least one processing option including one for changing playback parameters of the media playback data.

In a case where the target object includes text data and image data, display in the session window at least one processing option including one for performing layout design or content generation on the text data and image data.

In a case where the target object includes text data and/or image data from a second application, display in the session window at least one processing option including one for processing the text data and image data based on the functional service category provided by the second application.

In the embodiments of the present disclosure, the attribute information of the target object includes at least one of the following: text data, image data, access address, media playback data, mixed text and image data, text data and/or image data from a second application.

Exemplarily, when the target object includes text data, it may be necessary to change the data amount and data type of the text data, therefore, the processing options for changing the data amount of the text data and the processing options for changing the type of the text data are displayed and outputted in the session window. The processing options for changing the data amount of the text data can include at least one of summarization, extraction, polish, expansion, and continuation, and the processing options for changing the type of the text data can include at least one of text-to-image processing, text-to-video processing, and text-to-animation processing. It may also be necessary to perform some processing operations on the text data itself, such as questioning, search, and translation, therefore, the processing options for obtaining the associated data of the text data can also be displayed and outputted in the session window, which can include questioning, search, and translation. The text data includes Chinese text and foreign language text.

Further, exemplarily, when the text data is a long sentence in Chinese text, in order to understand the core content of the long sentence in a short time and intuitively, the processing options displayed in the session window can include at least one of summarization, abstraction, and text-to-animation processing.

Exemplarily, when the text data is a short word in Chinese, in order to clarify the meaning, usage scenario, and the like for the short word, the processing options displayed in the session window can include at least one of polish, expansion, and continuation.

Exemplarily, when the target object includes image data, in order to beautify the image data, processing options for changing image parameters or types are displayed and outputted in the session window. The processing options for changing image parameters of the image data can include photo editing, exposure, clarity, contrast, saturation, theme, and background color, and the processing options for changing the type of the image data can include image-to-text, image-to-video, and image-to-cartoon. In addition, it is also possible to consider doing some related operations on the image data itself, such as asking questions and searching for similar images, and thus the processing options for obtaining associated data of the image data are displayed and outputted in the session window, which can include asking questions and search.

In the embodiments of the present disclosure, when the target object includes an access address, a processing option for changing the access mode of the content corresponding to the access address is triggered. The processing option can be positioned by floating the mouse, and then triggered by a specific physical button to obtain an abstract, summary, and key information extracted from the content corresponding to the access address, so that a user can know the content pointed to by the access address without clicking to access. The processing option for changing the output type of the content corresponding to the access address is triggered to generate a hyperlink, a graphic link, or a summary icon. Here, the access address can include a uniform resource locator (URL), or a hyperlink. For example, when the target object includes a URL, the processing option for changing the output type of the content corresponding to the access address is triggered to generate a hyperlink. A hyperlink is a link form that is directly clicked on a document or web page. A hyperlink allows a user to jump directly to the web page or resource pointed to by the access address through a simple click operation.

Exemplarily, when the target object includes media playback data, in order to clearly understand the details of the media playback data, processing options for changing playback parameters are displayed and outputted in the session window, and the processing options for changing playback parameters can include playback rate, volume, and size. The media playback data includes at least one of audio data, video data, or animation data.

Exemplarily, when the target object includes mixed text and image data, in order to highlight the text data or image data, the processing options for layout design are displayed in the session window, and the processing options for layout design can include at least one of typesetting design, proportional relationship, and position relationship. In order to quickly share the target object including text data and image data, the processing options for content generation for the text data and image data are displayed in the session window, which can include generating a document, generating a PPT, and generating a picture.

In the embodiments of the present disclosure, when the target object includes text data and/or image data from a second application, the second application here can be a browser, a public account, an album, a document, a social application, or other applications that can display text data and/or image data.

For example, if the second application is a browser, and the functional service category that the browser can provide is browsing service, then the processing options displayed in the session window can include at least one of related document search, copy, and translation. If the second application is an album application, and the functional service category that the album application can provide is photo view, edit, and beautification, then the processing options displayed in the session window can include at least one of view, edit, and beautification.

In some embodiments, after executing S101, the following step shown in FIG. 2 is also included.
S201: In response to the target object switching from a current first object to a second object determined by the target input operation, update a first set of processing options currently displayed in the session window to a fourth set of processing options matching the second object, where at least one processing option in the fourth set of processing options is different from the processing options in the first set of processing options, and the first set of processing options is composed of at least one processing option recommended for the first object or its first processing result.

Here, a user reselects the operated object, that is, switches the first object to the second object, and then the set of processing options matching the first object is updated to the fourth set of processing options matching the second object. The set of processing options matching the first object is the set of processing options currently displayed in the session window. The set of processing options currently displayed in the session window consists of at least one processing option recommended for the first object or its first processing result. The fourth set of processing options consists of at least one processing option recommended for the second object or the processing result after a first processing of the second object.

Exemplarily, when the first object is text data, the first set of processing options displayed and outputted in the session window can include at least one of polish, continuation, translation, and asking questions. When switching from the first object to the second object, that is, switching from the original text data to image data, the session window will display and output a fourth set of processing options to update the processing options in the first set of processing options to at least one of image search, beautification, and asking questions. That is, there is at least one different processing option in the set of processing options for different objects.

In some embodiments, updating the set of processing options currently displayed in the session window to a fourth set of processing options matching the second object includes at least one of the following.

Identify attribute information of the second object, and update and display the fourth set of processing options in at least one of a main window, extended window, pop-up window, or floating window of the session window based on the attribute information.

Obtain source information of the second object, and update and display the fourth set of processing options in at least one of the main window, extended window, pop-up window, or floating window of the session window based on the source information.

Obtain user portrait information of the target user, and based on the user portrait information and the attribute information of the second object, update and display the fourth set of processing options in at least one of the main window, extended window, pop-up window or floating window of the session window.

In an optional solution, the fourth set of processing options corresponding to the second object with different attribute information is displayed and outputted in different windows. Exemplarily, when the attribute information of the second object is text data, a user is usually focused on viewing the text data, so the fourth set of processing options can be displayed in a floating window or a pop-up window. When the attribute information of the second object is a mixture of text and images, it is usually hoped that the user can conveniently select and operate the processing options while viewing the content of the mixture of the text and images, so the fourth set of processing options can be displayed in the main window.

In another optional solution, the fourth set of processing options corresponding to the second objects from different sources are displayed and outputted in different windows. Exemplarily, when the second object comes from a browser, a user usually chooses to do some translation, interpretation, and other operations on the second object from the browser, that is, to focus on viewing the second object on the browser. Therefore, the fourth set of processing options can be displayed through a floating window or a pop-up window. When the second object comes from an album application or a social application, it is usually hoped that the user can conveniently select and operate the processing options while viewing the images in the album application or viewing the relevant information in the social application. Therefore, the fourth set of processing options can be displayed through the main window or an extended window.

In another optional solution, the user portrait information and the attribute information of the second object are combined to select a window of a corresponding type to display the fourth set of processing options. The user portrait information can include at least one of the following: user identification, user habit data, and user historical behavior data. Exemplarily, when the second object is text data and the user portrait data includes user habit data, the user is usually accustomed to conveniently selecting and operating processing options for text data, therefore, the fourth set of processing options can be displayed through the main window.

After combining any two or three of the above solutions, the window for displaying the fourth set of processing options can be an intersection or a union of these solutions.

In some embodiments, obtaining a target object determined by the target input operation includes at least one of the following.

Determine an object covered by a trajectory operation acting on a display object of the second application as the target object.

Determine an object located by a gaze operation of the target user in a display area of the second application as the target object.

Determine an object in a display interface of the second application that matches the content described by a voice input operation of the target user as the target object.

Determine an object pointed to by a gesture operation of the target user in the display area of the second application as the target object.

In the embodiments of the present disclosure, an object covered by the trajectory operation acting on the display object of the second application is determined as the target object, where the display object refers to at least one of the text data, image data, audio and video data, and animation data displayed and outputted in the interface of the second application. An object covered by the trajectory operation refers to an object covered by a word selection operation, circling operation, or screenshot operation.

Exemplarily, when the second application is a document application, a user uses a mouse to perform a word selection operation such as pressing, sliding, and lifting at a target location to select a piece of text data, then the text data is the target object.

In the embodiments of the present disclosure, an object located by the target user's gaze operation in the display area of the second application is determined as the target object. That is, the gaze position of the target user in the display area of the second application is identified, and an object within a preset area of the gaze position is determined as the target object.

In the embodiments of the present disclosure, an object in the display interface of the second application that matches the content described by a target user's voice input operation is determined as the target object. That is, the target user's voice information is recognized, and an object in the display interface of the second application that matches the target user's voice information is determined as the target object.

In the embodiments of the present disclosure, an object pointed to by a target user's gesture operation in the display area of the second application is determined as the target object. That is, in the display area of the second application, the target user indicates or selects an object he wants to interact with through a gesture operation (such as a spatial gesture or a touch gesture), which is the target object.

In some embodiments, obtaining the target object determined by the target input operation includes the following steps as shown in FIG. 3.
S301: In response to identifying a target input operation performed by a target user on an application window of a second application, determine a window type of the application window.

Here, the window type is a window type that supports a target word extraction method, or a window type that does not support the target word extraction method.
S302: When the application window supports the target word extraction method, obtain the target object determined by the target input operation through a window message and a clipboard.
S303: When the application window does not support the target word extraction method, obtain the target object determined by the target input operation by taking a screenshot or simulating a copy operation.

In some embodiments, S301 may include: determining a window handle of the application window based on an acquired ending position of the target object; acquiring a window type name of the application window based on the window handle of the application window; determining a first word extraction method corresponding to the window type name of the application window based on a mapping relationship between preset window type names and preset word extraction methods; and determining whether the window type of the application window is a window type that supports or does not support the target word extraction method based on whether the first word extraction method is consistent with the target word extraction method.

The window handle can be understood as a unique identifier assigned to a window by the operating system. Through this identifier, the program can perform various operations and management on the window.

The window type name is specified when the window is created and is associated with the window handle. Therefore, the window type name of the application window can be obtained based on the window handle of the application window.

When the window type names of the application windows are different, the word extraction methods are different. Therefore, the present disclosure can determine a first word extraction method corresponding to the window type of the current application window according to the mapping relationship between the preset window type names and the preset word extraction methods established in advance.

When the first word extraction method is inconsistent with the target word extraction method, the window type of the current application window is determined to be a window type that does not support the target word extraction method. When the first word extraction method is consistent with the target word extraction method, the window type of the current application window is determined to be a window type that supports the target word extraction method.

In some embodiments, obtaining the target object determined by the target input operation through a window message and a clipboard includes: sending the window message to the application window or the parent window of the application window based on an acquired ending position of the target object; copying the target object in response to the window message and storing the target object in the clipboard; and obtaining the target object determined by the target input operation from the clipboard.

That is, by sending a window message, namely a WM-COPY message, to the application window or the parent window of the application window, the application window or the parent window of the application window responds to the WM-COPY message in the sending window, copies the target object and stores it in the clipboard, and then the target object can be obtained from the clipboard.

In some embodiments, sending the window message to the application window or the parent window of the application window based on the acquired ending position of the target object includes: determining the window handle of the application window based on the ending position of the target object; determining the application name of the second application based on the window handle of the application window; and sending the window message to the application window or the parent window of the application window based on the application name of the second application.

In the embodiments of the present disclosure, the application name of the second application is used to determine whether to send the window message to the application window or to the parent window of the application window. For example, when the second application is a document application, the window message is sent to the application window. When the second application is a PPT or a browser, the window message is sent to the parent window of the application window.

Furthermore, specifically, based on the window handle of the application window, the window message is sent to the application window, and based on the parent window handle for the window handle of the application window, a window message is sent to the parent window of the application window.

In the embodiments of the present disclosure, if the application window does not support the target word extraction method, the target object determined by the target input operation can be obtained by a screenshot. Specifically, a rectangular area is determined based on the start position and ending position of the target object, the rectangular area is intercepted, and saved in image format, and then the saved image is recognized and processed to obtain the target object and store it in the clipboard. Alternatively, if the application window does not support the target word extraction method, the target object determined by the target input operation can be obtained by simulating a copy operation, that is, by simulating pressing the copy key on the keyboard through the programming interface, copying the target object and storing it in the clipboard.

It should be noted that by simulating the pressing of the copy key on the keyboard through the programming interface, that is, simulating the keyboard Ctrl+C method because it simulates the user's key operation, the operating system will interrupt the processing operation being performed by the operating system and give priority to the user's keyboard input. This will cause some menu messages of the current application. For example, when a paragraph in the document application is selected, the menu items such as font and font size that should have appeared will disappear. Therefore, without affecting the original application function of the second application, the target object determined by the target input operation is obtained by taking a screenshot or simulating a copy operation. In a case of affecting the original application function of the second application, the target object determined by the target input operation is obtained by taking a screenshot.

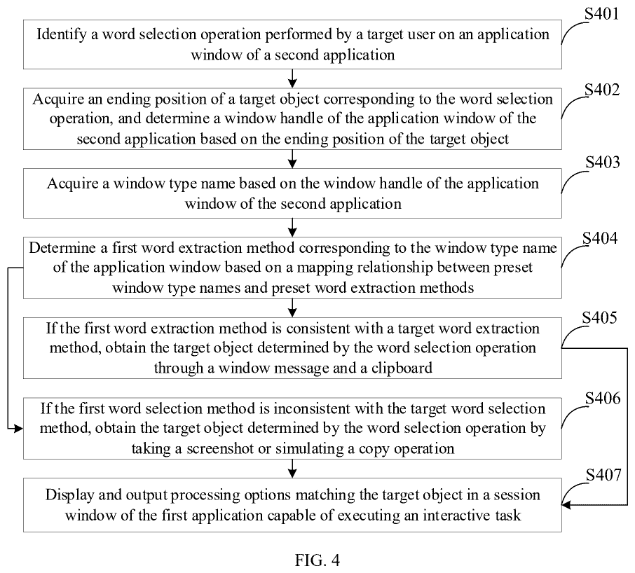

Based on the above embodiments, the present disclosure illustrates a data processing method. FIG. 4 is a flowchart of a data processing method according to the embodiments of the present disclosure. As shown in FIG. 4, the data processing method can include the following steps.
S401: Identify a word selection operation performed by a target user on an application window of a second application.
S402: Acquire an ending position of a target object corresponding to the word selection operation, and determine a window handle of the application window of the second application based on the ending position of the target object.
S403: Acquire a window type name based on the window handle of the application window of the second application.
S404: Determine a first word extraction method corresponding to the window type name of the application window based on a mapping relationship between preset window type names and preset word extraction methods.
S405: If the first word extraction method is consistent with the target word extraction method, obtain the target object determined by the word selection operation through a window message and a clipboard.
S406: If the first word selection method is inconsistent with the target word selection method, obtain the target object determined by the word selection operation by taking a screenshot or simulating a copy operation.
S407: Display and output processing options matching the target object in a session window of the first application capable of executing an interactive task.

S407 specifically includes the following three solutions.

The first solution: load the target object into the session window of the first application, and display a first set of processing options recommended for the target object, so as to perform a corresponding processing operation on the target object in response to a selected operation of the target user.

The second solution: display a first processing result obtained after a first processing of the target object in the session window of the first application, and display a second set of processing options recommended for a second processing of the target object, so as to perform a second processing operation on the target object in response to a selected operation of the target user.

The third solution: display a first processing result obtained after the first processing of the target object in the session window of the first application, and display a third set of processing options recommended for the first processing result, so as to perform a corresponding processing operation on the first processing result in response to a selected operation of the target user, where the third set of processing options includes the processing options corresponding to the first processing.

Exemplarily, after executing S401 to S404, S405, or S406, if the first solution included in S407 is executed, in this regard, an embodiment of the present disclosure illustrates an interaction diagram between a first application and a second application, as shown in FIG. 5. A user selects a piece of text data, i.e., the bold part, by a word selection operation in the application window of the second application, loads the piece of text data into the session window of the first application as part of the question input, and displays a first set of processing options recommended for the piece of text data, including summarization, translation, polish and continuation. Subsequently, after the user triggers the summarization processing option, the session window of the first application displays the summary content of the piece of text data. Other processing options are similar to the summarization processing option, and can be used for reference.

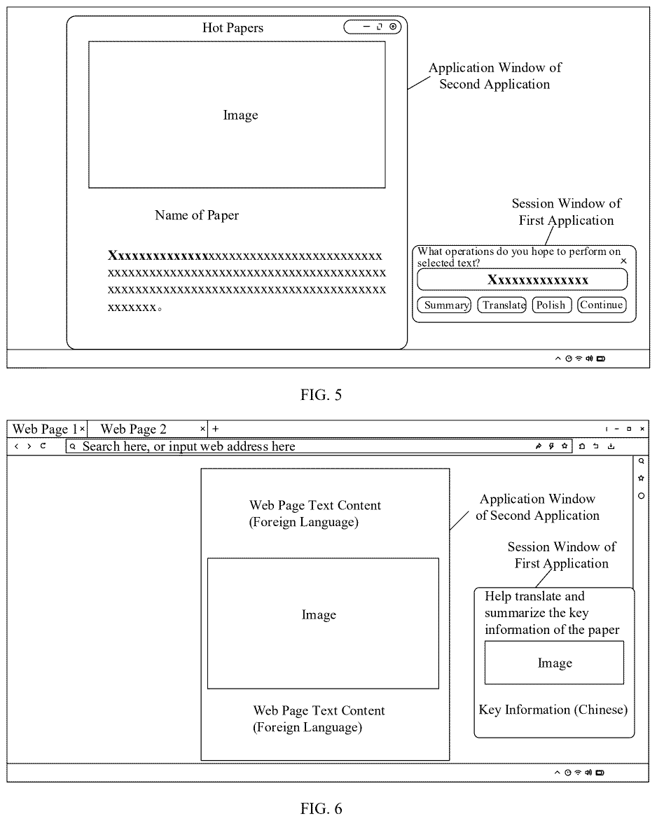

Exemplarily, after executing S401 to S404, S405, or S406, if the second solution included in S407 is executed, in this regard, an embodiment of the present disclosure illustrates an interaction diagram of a first application and a second application, as shown in FIG. 6. A user selects all the contents in the application window of the second application on the web page 2, including foreign text data and image data. The system extracts a summary of the foreign text data and translates it into Chinese by default, and displays the obtained first processing result in a session window of the first application. At the same time, a second set of processing options recommended for the second processing of the foreign text data and the image data can also be displayed, or a third set of processing options recommended for the first processing result can be displayed (this part is not drawn in FIG. 6).

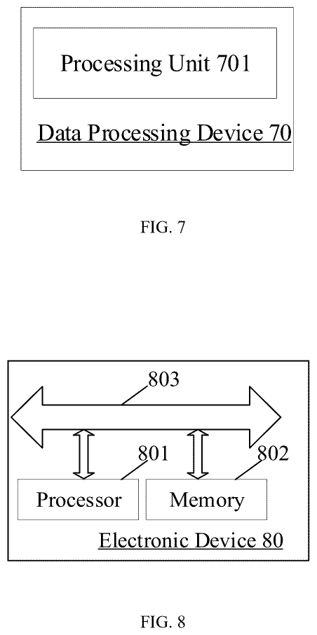

In order to implement the methods of the embodiments of the present disclosure, based on the same innovative concept, a data processing device is also provided in the embodiments of the present disclosure. FIG. 7 is a schematic structural diagram of a data processing device according to the embodiments of the present disclosure. As shown in FIG. 7, the data processing device 70 includes the following units.

A processing unit 701, which is configured to, in response to obtaining a target object determined by a target input operation, display and output processing options matching the target object in a session window of a first application capable of performing an interactive task.

Here, at least one of the processing options corresponding to different objects is different, and a processing option is configured to perform a corresponding processing operation on the target object after being triggered.

In the embodiments of the present disclosure, for different objects, the session window of the first application will adaptively display and output processing options corresponding to different objects. In this way, the user does not need to frequently switch tools, and can directly trigger the processing options to execute the corresponding processing operations, thereby greatly improving data processing efficiency.

In some embodiments, the processing unit 701 is further configured to process one of the following operations.

In response to obtaining the target object, load the target object into the session window of the first application, and display a first set of processing options recommended for the target object, so as to perform a corresponding processing operation on the target object in response to a selected operation of the target user.

In response to obtaining the target object, display a first processing result obtained after performing a first processing on the target object in a session window of the first application, and display a second set of processing options recommended for performing a second processing on the target object, so as to perform a second processing operation on the target object in response to a selected operation of the target user, where the second set of processing options does not include a processing option corresponding to the first processing.

In response to obtaining the target object, display a first processing result obtained after a first processing of the target object in a session window of the first application, and display a third set of processing options recommended for the first processing result, so as to perform a corresponding processing operation on the first processing result in response to a selected operation of a target user, where the third set of processing options includes processing options corresponding to the first processing.

In some embodiments, the processing unit 701 is further configured to process at least one of the following operations.

Identify attribute information of the target object, and display and output at least one matching processing option in the session window based on the attribute information.

Obtain source information of the target object, and display and output a set of matching processing options in the session window based on the source information.

Identify a user intention indicated by the target input operation and/or the target object, and display at least one matching processing option in the session window based on the user intention.

Obtain configuration information and operation information of an electronic device, and display and output at least one processing option matching the target object in the session window based on the configuration information and the operation information.

Obtain user portrait information of the target user, and display and output at least one matching processing option in the session window based on the user portrait information and the attribute information of the target object.

In some embodiments, the processing unit 701 is further configured to process at least one of the following operations.

In a case where the target object includes text data, display in the session window at least one processing option including one for changing the data amount or type of the text data and/or for obtaining associated data of the text data.

In a case where the target object includes image data, display in the session window at least one processing option including one for changing an image parameter or type of the image data and/or for acquiring associated data of the image data.

In a case where the target object includes an access address, display in the session window at least one processing option including one for changing an access mode or an output type of content corresponding to the access address.

In a case where the target object includes media playback data, display in the session window at least one processing option including one for changing playback parameters of the media playback data.

In a case where the target object includes text data and image data, display in the session window at least one processing option including one for performing layout design or content generation on the text data and image data.

In a case where the target object includes text data and/or image data from a second application, display at least one processing option including one for processing the text data and image data in the session window based on a functional service category provided by the second application, where the second application is an application different from the first application.

In some embodiments, the processing unit 701 is further configured to update the set of processing options currently displayed in the session window to a fourth set of processing options matching a second object in response to the target object being switched from the current first object to the second object determined by the target input operation.

Here, at least one processing option in the fourth set of processing options is different from the processing options in the set of processing options currently displayed in the session window, and the set of processing options currently displayed in the session window consists of at least one processing option recommended for the first object or its first processing result.

In some embodiments, the processing unit 701 is further configured to process at least one of the following operations.

Identify attribute information of the second object, and update and display the fourth set of processing options in at least one of a main window, an extended window, a pop-up window, or a floating window of the session window based on the attribute information.

Obtain source information of the second object, and update and display the fourth set of processing options in at least one of a main window, an extended window, a pop-up window, or a floating window of the session window based on the source information.

Obtain user portrait information of the target user, and based on the user portrait information and the attribute information of the second object, update and display the fourth set of processing options in at least one of the main window, extended window, pop-up window or floating window of the session window.

In some embodiments, the processing unit 701 is further configured to process at least one of the following operations.

Determine an object covered by a trajectory operation acting on the display object of the second application as the target object.

Determine an object located by a gaze operation of the target user in the display area of the second application as the target object.

Determine an object in the display interface of the second application that matches the content described by a voice input operation of the target user as the target object.

Determine an object pointed to by a gesture operation of the target user in the display area of the second application as the target object.

In some embodiments, the processing unit 701 is further configured to, in response to identifying a target input operation performed by a target user on an application window of a second application, obtain a window type of the application window.

In a case where the application window supports the target word extraction method, the target object of the target input operation is obtained through a window message and clipboard; or when the application window does not support the target word extraction method, the target object of the target input operation is obtained by taking a screenshot or simulating a copy operation.

In some embodiments, the processing unit 701 is also configured to determine the window handle of the application window based on the acquired ending position of the target object; obtain the window type name of the application window based on the window handle of the application window; determine the first word extraction method corresponding to the window type name of the application window based on the mapping relationship between preset window type names and preset word extraction methods; and determine whether the window type of the application window is a window type that supports or does not support the target word extraction method based on whether the first word extraction method is consistent with the target word extraction method.

In some embodiments, the processing unit 701 is also configured to send a window copy message to the application window or the parent window of the application window based on the acquired ending position of the target object; in response to the window copy message, copy the target object and store it in the clipboard; and obtain the target object determined by the target input operation from the clipboard.

In some embodiments, the processing unit 701 is also configured to determine the window handle of the application window based on the ending position of the target object; determine the application name of the second application based on the window handle of the application window; and send the window copy message to the application window or the parent window of the application window based on the application name of the second application.

The embodiments of the present disclosure further provide another electronic device. FIG. 8 is a schematic structural diagram of the electronic device according to the embodiments of the present disclosure. As shown in FIG. 8, the electronic device 80 includes processor(s) 801 and a memory 802 configured to store a computer program that can be run on the processor. In one embodiment, the computer program may include an AI (artificial intelligence) model running on a processor. In another embodiment, the computer program may allow an AI model to run on a processor. In one example, AI models may be implemented through programming and deploying the computer program to processor(s) (such as CPUs or GPUs) for execution.

The processor 801 is configured to execute the method steps in the aforementioned embodiments when running the computer program.

Apparently, in actual application, as shown in FIG. 8, the various components in the electronic device 80 are coupled together via a bus system 803. It is understandable that the bus system 803 is configured to realize the connection and communication between these components. In addition to the data bus, the bus system 803 also includes a power bus, a control bus, and a status signal bus. However, for the sake of clarity, various buses are labeled as the bus system 803 in FIG. 8.

In practical applications, the processor can be at least one of an application-specific integrated circuit (ASIC), a digital signal processing device (DSPD), a programmable logic device (PLD), a field-programmable gate array (FPGA), a controller, a microcontroller, and a microprocessor. It can be understood that for different devices, the electronic device configured to implement the functions of the processor can also be different, which is not specifically limited in the embodiments of the present disclosure.

The memory can be a volatile memory, such as a random access memory (RAM); or a non-volatile memory, such as a read-only memory (ROM), a flash memory, a hard disk (HDD) or a solid-state drive (SSD); or a combination of thereof. The memory can provide instructions and data to the processor.

In an exemplary embodiment, the present disclosure also provides a computer-readable storage medium for storing a computer program.

Optionally, the computer-readable storage medium can be applied to any one of the methods in the embodiments of the present disclosure, and the computer program enables the computer to execute the corresponding processes implemented by the processor in each method in the embodiments of the present disclosure. For the sake of brevity, the specific details are not repeated here.

Illustratively, an embodiment of the present disclosure further provides a computer program product, including a computer program, which can be executed by a processor of an electronic device to complete the steps of any of the aforementioned methods.

In the embodiments provided in the present disclosure, it should be understood that the disclosed devices and methods can be implemented in other ways. The device embodiments described above are merely schematic. For example, the division of the units is merely a logical function division. There can be other division methods in actual implementation, such as multiple units or components can be combined, or can be integrated into another system, or some features can be ignored or not executed. In addition, the coupling, direct coupling, or communication connection between the components shown or discussed can be through some interfaces, and the indirect coupling or communication connection of the devices or units can be electrical, mechanical or other forms.

The units described above as separate components can or cannot be physically separated, and the components displayed as units can or cannot be physical units, that is, these units can be located in one place or distributed on multiple network units; some or all of the units can be selected according to actual needs to achieve the purpose of the present disclosure.

In addition, all functional units in the embodiments of the present disclosure can be integrated into one processing module, or each unit can be a separate unit, or two or more units can be integrated into one unit. The above integrated unit can be implemented in the form of hardware or in the form of hardware plus software functional units. A person of ordinary skill in the art can understand that all or part of the steps of the above method embodiments can be completed by hardware related to program instructions, and the above program can be stored in a computer-readable storage medium, which, when executed, executes the steps of the above method embodiments. The above storage medium includes various media that can store program codes, such as mobile storage devices, ROM, RAM, magnetic disks or optical disks.

The methods disclosed in the method embodiments provided in the disclosure can be arbitrarily combined without conflict to obtain new method embodiments.

The features disclosed in the device embodiments provided in the disclosure can be arbitrarily combined without conflict to obtain new device embodiments.

The features disclosed in several method or device embodiments provided in the disclosure can be arbitrarily combined without conflict to obtain new method embodiments or device embodiments.

The present disclosure provides a data processing method, device, storage medium and product. For different objects, a session window of the first application can adaptively display and output processing options corresponding to different objects. In this way, a user does not need to frequently switch tools, and can directly trigger the processing options to execute the corresponding processing operations, thereby greatly improving the data processing efficiency.

The above description is merely a specific implementation mode of the present disclosure, but the protection scope of the present disclosure is not limited thereto. A person skilled in the art can easily think of changes or substitutions within the technical scope disclosed by the present disclosure, which should be covered by the protection scope of the present disclosure.

What is claimed is:

1. A data processing method, comprising:
in response to obtaining a target object determined by a target input operation, displaying and outputting processing options matching the target object in a session window of a first application capable of performing an interactive task,
wherein at least one of the processing options corresponding to different objects is different, and a processing option is configured to perform a corresponding processing operation on the target object after being triggered.

2. The method according to claim 1, wherein displaying and outputting the processing options matching the target object in the session window of the first application capable of performing the interactive task includes one or more of a following:
in response to obtaining the target object, loading the target object into the session window of the first application, and displaying a first set of processing options recommended for the target object, so as to perform a corresponding processing operation on the target object in response to a selected operation of a target user;
in response to obtaining the target object, displaying a first processing result obtained after performing a first processing on the target object in the session window of the first application, and displaying a second set of processing options recommended for performing a second processing on the target object, so as to perform a second processing operation on the target object in response to a selected operation of the target user, wherein the second set of processing options does not include a processing option corresponding to the first processing; or
in response to obtaining the target object, displaying a first processing result obtained after performing a first processing on the target object in the session window of the first application, and displaying a third set of processing options recommended for the first processing result, so as to perform a corresponding processing operation on the first processing result in response to a selected operation of a target user, wherein the third set of processing options includes processing options corresponding to the first processing.

3. The method according to claim 1, wherein displaying and outputting the processing options matching the target object in the session window of the first application capable of performing the interactive task includes one or more of a following:
identifying attribute information of the target object, and displaying and outputting at least one matching processing option in the session window based on the attribute information;
obtaining source information of the target object, and displaying and outputting at least one matching processing option in the session window based on the source information;
identifying a user intention indicated by the target input operation and/or the target object, and displaying and outputting at least one matching processing option in the session window based on the user intention;
obtaining configuration information and operation information of an electronic device, and displaying and outputting at least one processing option matching the target object in the session window based on the configuration information and the operation information; or
obtaining user portrait information of a target user, and displaying and outputting at least one matching processing option in the session window based on the user portrait information and the attribute information of the target object.

4. The method according to claim 3, wherein displaying and outputting at least one matching processing option in the session window based on the attribute information includes one or more of a following:
in a case where the target object includes text data, displaying in the session window at least one processing option including one for changing a data amount or type of the text data and/or for obtaining associated data of the text data;
in a case where the target object includes image data, displaying in the session window at least one processing option including one for changing an image parameter or type of the image data and/or for acquiring associated data of the image data;
in a case where the target object includes an access address, displaying in the session window at least one processing option including one for changing an access mode or an output type of content corresponding to the access address;
in a case where the target object includes media playback data, displaying in the session window at least one processing option including one for changing playback parameters of the media playback data;
in a case where the target object includes text data and image data, displaying in the session window at least one processing option including one for performing layout design or content generation on the text data and image data; or
in a case where the target object includes text data and/or image data from a second application, displaying at least one processing option for processing the text data and image data in the session window based on a functional service category provided by the second application, wherein the second application is an application different from the first application.

5. The method according to claim 1, further comprising:
in response to the target object being switched from a current first object to a second object determined by the target input operation, updating a first set of processing options currently displayed in the session window to a fourth set of processing options matching the second object,
wherein at least one processing option in the fourth set of processing options is different from processing options in the first set of processing options, and the first set of processing options includes at least one processing option recommended for the first object or a first processing result of the first object.

6. The method according to claim 5, wherein updating the first set of processing options currently displayed in the session window to the fourth set of processing options matching the second object includes one or more of a following:
identifying attribute information of the second object, and updating and displaying the fourth set of processing options in at least one of a main window, extended window, pop-up window, or floating window of the session window based on the attribute information;
obtaining source information of the second object, and updating and displaying the fourth set of processing options in at least one of the main window, extended window, pop-up window, or floating window of the session window based on the source information; or
obtaining user portrait information of a target user, and based on the user portrait information and the attribute information of the second object, updating and displaying the fourth set of processing options in at least one of the main window, extended window, pop-up window or floating window of the session window.

7. The method according to claim 1, wherein obtaining the target object determined by the target input operation includes one or more of a following:
determining an object covered by a trajectory operation acting on a display object of a second application as the target object;
determining an object located by a gaze operation of the target user in a display area of the second application as the target object;
determining an object in a display interface of the second application that matches content described by a voice input operation of the target user as the target object; or
determining an object pointed to by a gesture operation of the target user in the display area of the second application as the target object.

8. The method according to claim 7, wherein obtaining the target object determined by the target input operation comprises:
in response to identifying the target input operation performed by the target user on an application window of the second application, determining a window type of the application window; and
in a case where the application window supports a target word extraction method, obtaining the target object determined by the target input operation through a window message and clipboard; or,
in a case where the application window does not support the target word extraction method, obtaining the target object determined by the target input operation by taking a screenshot or simulating a copy operation.

9. The method according to claim 8, wherein determining the window type of the application window comprises:
determining a window handle of the application window based on an acquired ending position of the target object;
obtaining a window type name of the application window based on the window handle of the application window;
determining a first word extraction method corresponding to the window type name of the application window based on a mapping relationship between preset window type names and preset word extraction methods; and
based on whether a first word selection method is consistent with a target word selection method, determining that the window type of the application window is a window type that supports or does not support the target word selection method.

10. An electronic device, including a memory and one or more processors, wherein the memory stores a computer program executable by the one or more processors, and when executing the computer program, the one or more processor are configured to perform:
in response to obtaining a target object determined by a target input operation, displaying and outputting processing options matching the target object in a session window of a first application capable of performing an interactive task,
wherein at least one of the processing options corresponding to different objects is different, and a processing option is configured to perform a corresponding processing operation on the target object after being triggered.

11. The electronic device according to claim 10, wherein the one or more processors are further configured to perform one or more of a following:
in response to obtaining the target object, loading the target object into the session window of the first application, and displaying a first set of processing options recommended for the target object, so as to perform a corresponding processing operation on the target object in response to a selected operation of a target user;
in response to obtaining the target object, displaying a first processing result obtained after performing a first processing on the target object in the session window of the first application, and displaying a second set of processing options recommended for performing a second processing on the target object, so as to perform a second processing operation on the target object in response to a selected operation of the target user, wherein the second set of processing options does not include a processing option corresponding to the first processing; or
in response to obtaining the target object, displaying a first processing result obtained after performing a first processing on the target object in the session window of the first application, and displaying a third set of processing options recommended for the first processing result, so as to perform a corresponding processing operation on the first processing result in response to a selected operation of a target user, wherein the third set of processing options includes processing options corresponding to the first processing.

12. The electronic device according to claim 10, wherein the one or more processors are further configured to perform one or more of a following:
identifying attribute information of the target object, and displaying and outputting at least one matching processing option in the session window based on the attribute information;
obtaining source information of the target object, and displaying and outputting at least one matching processing option in the session window based on the source information;
identifying a user intention indicated by the target input operation and/or the target object, and displaying and outputting at least one matching processing option in the session window based on the user intention;
obtaining configuration information and operation information of an electronic device, and displaying and outputting at least one processing option matching the target object in the session window based on the configuration information and the operation information; or
obtaining user portrait information of a target user, and displaying and outputting at least one matching processing option in the session window based on the user portrait information and the attribute information of the target object.

13. The electronic device according to claim 12, wherein the one or more processors are further configured to perform one or more of a following:
in a case where the target object includes text data, displaying in the session window at least one processing option including one for changing a data amount or type of the text data and/or for obtaining associated data of the text data;
in a case where the target object includes image data, displaying in the session window at least one processing option including one for changing an image parameter or type of the image data and/or for acquiring associated data of the image data;
in a case where the target object includes an access address, displaying in the session window at least one processing option including one for changing an access mode or an output type of content corresponding to the access address;
in a case where the target object includes media playback data, displaying in the session window at least one processing option including one for changing playback parameters of the media playback data;
in a case where the target object includes text data and image data, displaying in the session window at least one processing option including one for performing layout design or content generation on the text data and image data; or
in a case where the target object includes text data and/or image data from a second application, displaying at least one processing option for processing the text data and image data in the session window based on a functional service category provided by the second application, wherein the second application is an application different from the first application.

14. The electronic device according to claim 10, wherein the one or more processors are further configured to perform:
in response to the target object being switched from a current first object to a second object determined by the target input operation, updating a first set of processing options currently displayed in the session window to a fourth set of processing options matching the second object,
wherein at least one processing option in the fourth set of processing options is different from processing options in the first set of processing options, and the first set of processing options includes at least one processing option recommended for the first object or a first processing result of the first object.

15. The electronic device according to claim 14, wherein the one or more processors are further configured to perform one or more of a following:
identifying attribute information of the second object, and updating and displaying the fourth set of processing options in at least one of a main window, extended window, pop-up window, or floating window of the session window based on the attribute information;
obtaining source information of the second object, and updating and displaying the fourth set of processing options in at least one of the main window, extended window, pop-up window, or floating window of the session window based on the source information; or
obtaining user portrait information of a target user, and based on the user portrait information and the attribute information of the second object, updating and displaying the fourth set of processing options in at least one of the main window, extended window, pop-up window or floating window of the session window.

16. The electronic device according to claim 10, wherein the one or more processors are further configured to perform one or more of a following:
determining an object covered by a trajectory operation acting on a display object of a second application as the target object;
determining an object located by a gaze operation of the target user in a display area of the second application as the target object;
determining an object in a display interface of the second application that matches content described by a voice input operation of the target user as the target object; or
determining an object pointed to by a gesture operation of the target user in the display area of the second application as the target object.

17. The electronic device according to claim 16, wherein the one or more processors are further configured to perform:
in response to identifying the target input operation performed by the target user on an application window of the second application, determining a window type of the application window; and
in a case where the application window supports a target word extraction method, obtaining the target object determined by the target input operation through a window message and clipboard; or,
in a case where the application window does not support the target word extraction method, obtaining the target object determined by the target input operation by taking a screenshot or simulating a copy operation.

18. The electronic device according to claim 17, wherein the one or more processors are further configured to perform:
determining a window handle of the application window based on an acquired ending position of the target object;
obtaining a window type name of the application window based on the window handle of the application window;
determining a first word extraction method corresponding to the window type name of the application window based on a mapping relationship between preset window type names and preset word extraction methods; and
based on whether a first word selection method is consistent with a target word selection method, determining that the window type of the application window is a window type that supports or does not support the target word selection method.

19. A non-transitory computer-readable storage medium, storing a computer program that, when being executed, causes at least one processor to implement a data processing method comprising:
in response to obtaining a target object determined by a target input operation, displaying and outputting processing options matching the target object in a session window of a first application capable of performing an interactive task,
wherein at least one of the processing options corresponding to different objects is different, and a processing option is configured to perform a corresponding processing operation on the target object after being triggered.

20. The non-transitory computer-readable storage medium according to claim 19, wherein the computer program, when being executed, further causes at least one processor to implement one or more of a following:
in response to obtaining the target object, loading the target object into the session window of the first application, and displaying a first set of processing options recommended for the target object, so as to perform a corresponding processing operation on the target object in response to a selected operation of a target user;
in response to obtaining the target object, displaying a first processing result obtained after performing a first processing on the target object in the session window of the first application, and displaying a second set of processing options recommended for performing a second processing on the target object, so as to perform a second processing operation on the target object in response to a selected operation of the target user, wherein the second set of processing options does not include a processing option corresponding to the first processing; or
in response to obtaining the target object, displaying a first processing result obtained after performing a first processing on the target object in the session window of the first application, and displaying a third set of processing options recommended for the first processing result, so as to perform a corresponding processing operation on the first processing result in response to a selected operation of a target user, wherein the third set of processing options includes processing options corresponding to the first processing.
